(19) United States
(12) Patent Application Publication
(10) Pub. No.: US 2018/0340347 A1
(43) Pub. Date: Nov. 29, 2018

(54) AUTOMATIC INSTANT TENT FRAME

(71) Applicant: Young Sub KIM, Yangju-si (KR)

(72) Inventor: Young Sub KIM, Yangju-si (KR)

(21) Appl. No.: 15/981,123

(22) Filed: May 16, 2018

(30) Foreign Application Priority Data
May 29, 2017 (KR) 10-2017-0066374

(51) Int. Cl. E04H 15/48; F16H 21/54; F16H 19/00

(52) U.S. Cl. CPC E04H 15/48; F16H 2019/008; F16H 19/001; F16H 21/54

(57) ABSTRACT

The present invention relates to an automatic instant tent frame including: a head for collectively coupling a plurality of legs thereto; and the plurality of legs for providing a framework of an automatic instant tent, each leg having an upper pole and a lower pole coupled integrally to each other by means of a pole connector, wherein the head includes: a hub for collectively coupling a plurality of pole couplers thereto; the pole couplers each having one end portion coupled to one end of the upper pole and the other end pivot-coupled to a corresponding coupling wall of the hub; a stopper coupled to top of the hub; a compression spring fitted to a through hole formed on the center of a coupling pillar of the hub; coupling nuts disposed on top and underside of the stopper; and a coupling bolt fitted to the compression spring.

### BACKGROUND OF THE INVENTION

### Field of the Invention

The present invention relates to an automatic instant tent frame, and more particularly, to an automatic instant tent frame that is configured to allow a plurality of legs to at the same time operate, so that it can easily unfold and fold an automatic instant tent.

### Background of the Related Art

Generally, an instant tent includes a tent frame and a tent body (tent cloth) combined integrally to each other so that it can be easily unfolded and folded just with a simple operation.

The instant tent is classified into an automatic instant tent and a semi-automatic instant tent. In this case, the automatic instant tent is provided with auxiliary means like springs, and through a simple manipulation of the auxiliary means, accordingly, a plurality of poles operates at the same time so that the automatic instant tent can be easily unfolded and folded.

The inventor has studied for many years to develop a tent easily unfoldable and foldable by everyone through simple manipulation as mentioned above.

For example, there is provided Korean Patent Registration No. 10-1456800 entitled ‘automatic tent frame’ as filed by the same applicant as the invention, thereby providing many conveniences in people's leisure activities.

FIG. 18 is a separate perspective view showing the conventional automatic tent frame, FIG. 19 is a perspective view showing an upper coupler of the conventional automatic tent frame, and FIG. 20 is a sectional view showing a state where main poles coupled to the upper coupler of the conventional automatic tent frame.

As shown in FIGS. 18 to 20, the conventional automatic tent frame, which includes a pipe module 100, an upper coupler 200, a lower coupler 300, an extension spring 400, a plurality of main poles 500, and a plurality of support poles 600, is configured to allow the plurality of main poles 500 to be hinge-coupled to a plurality of main pole coupling grooves 210 formed along the outer periphery of the upper coupler 200. At this time, it should be noted that the reference numerals as mentioned above are indicated in FIGS. 18 to 20.

In case of the conventional automatic tent frame, by the way, the main poles coupled to the upper coupler have to be one by one unfolded or folded by a user's hand if it is desired to unfold or fold a tent, so that it is very inconvenient and hard to install and remove the tent, a lot of time is spent in installation and removal of the tent, the danger in the installation or removal of the instant tent like damage to a user's hand caught to the frame may occur, and abrasion or failure caused by friction between frame components may be generated at the time when the tent is folded or in the state where the tent is folded. Accordingly, there is a definite need to improve the conventional automatic tent frame.

### SUMMARY OF THE INVENTION

Accordingly, the present invention has been made in view of the above-mentioned problems occurring in the prior art, and it is an object of the present invention to provide an automatic instant tent frame that is capable of installing and removing a tent in rapid, simple, and easy manners, removing the danger in the installation or removal of the tent like damage to a user's hand caught thereto, and avoiding abrasion or failure caused by friction between frame components at the time when the tent is folded or in the state where the tent is folded.

To accomplish the above-mentioned object, according to the present invention, there is provided an automatic instant tent frame including: a head serving as an upper structure adapted to collectively couple a plurality of legs thereto; and the plurality of legs serving as a lower structure adapted to provide a framework of an automatic instant tent and to support a tent cloth thereagainst to provide an outer shape of the automatic instant tent, each leg having an upper pole and a lower pole coupled integrally to each other by means of a pole connector, wherein the head includes: a hub for collectively coupling a plurality of pole couplers thereto; the plurality of pole couplers each having one end portion coupled to one end of the upper pole and the other end pivot-coupled to a corresponding coupling wall of the hub; a stopper coupled to top of the hub to selectively keep an unfolded or folded state of the plurality of pole couplers pivot-coupled to the hub; a compression spring fitted to a through hole formed on the center of a coupling pillar of the hub; coupling nuts disposed on top and underside of the stopper; and a coupling bolt fitted to the compression spring in such a manner as to be coupled to top and underside of a circular plate of the stopper coupled to the top of the hub by means of the coupling nuts.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a state where an automatic instant tent frame according to the present invention is unfolded;

FIG. 2 is a top view showing the plane of a head in the automatic instant tent frame according to the present invention;

FIG. 3 is a partially separate perspective view showing the head;

FIG. 4 is a perspective view showing top of a hub in the automatic instant tent frame according to the present invention;

FIG. 5 is a perspective view showing underside of the hub;

FIG. 6 is a bottom view showing space portions on the underside of the hub;

FIG. 7 is a side view showing a pole coupler in the automatic instant tent frame according to the present invention;

FIG. 8 is a perspective view showing a guider and a friction prevention projection of the pole coupler;

FIG. 9 is a perspective view showing a locking groove and a connection gear of the pole coupler;

FIG. 10 is a top view showing a state where pole couplers are coupled to the hub in the automatic instant tent frame according to the present invention;

FIG. 11 is a perspective view showing top of a stopper in the automatic instant tent frame according to the present invention;

FIG. 12 is a perspective view showing underside of the stopper;

FIG. 13 is a bottom view showing the stopper;

FIG. 14 is a top view showing the plane state of the automatic instant tent frame according to the present invention;

FIG. 15 is a perspective view showing legs when an automatic instant tent is folded, wherein the stopper of the head is raised upward;

FIG. 16 is a perspective view showing a state where lower poles of the legs are unfolded so as to unfold the automatic instant tent, wherein the stopper of the head is still raised upward;

FIG. 17 is a perspective view showing a state where the automatic instant tent is completely unfolded, wherein the stopper of the head is coupled to the hub of the head.

FIG. 18 is a separate perspective view showing the conventional automatic tent frame;

FIG. 19 is a perspective view showing an upper coupler of the conventional automatic tent frame; and

FIG. 20 is a sectional view showing a state where main poles coupled to the upper coupler of the conventional automatic tent frame.

### DETAILED DESCRIPTION OF THE PREFERRED EMBODIMENTS

Now, an explanation on an automatic instant tent frame according to the present invention will be given with reference to the attached drawings.

In the description, the terms as will be discussed later are defined in accordance with the functions of the present invention, but may be varied under the intention or regulation of a user or operator. Therefore, they should be defined on the basis of the whole scope of the present invention. Before the present invention is disclosed and described, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill n the art to variously employ the present invention in virtually any appropriately detailed structure. If it is determined that the detailed explanation on the well known technology related to the present invention makes the scope of the present invention not clear, the explanation will be avoided for the brevity of the description. The present invention is disclosed with reference to the attached drawings wherein the corresponding parts in the embodiments of the present invention are indicated by corresponding reference numerals and the repeated explanation on the corresponding parts will be avoided.

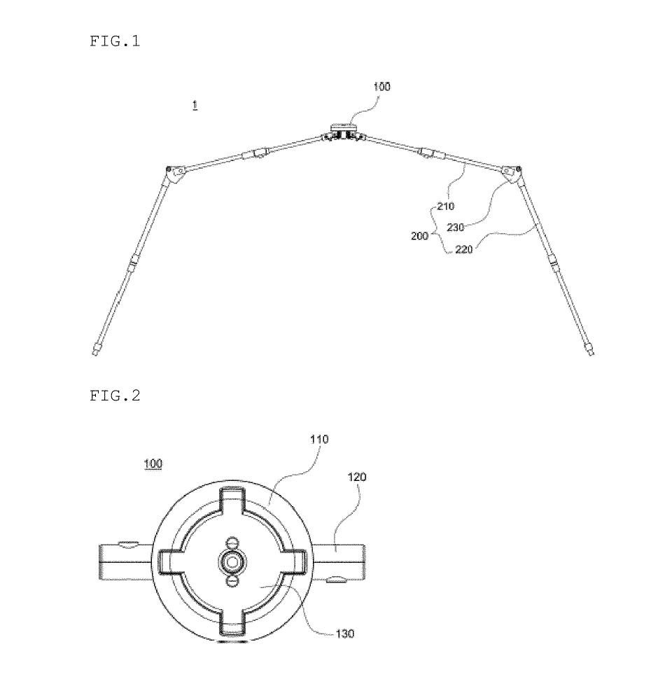

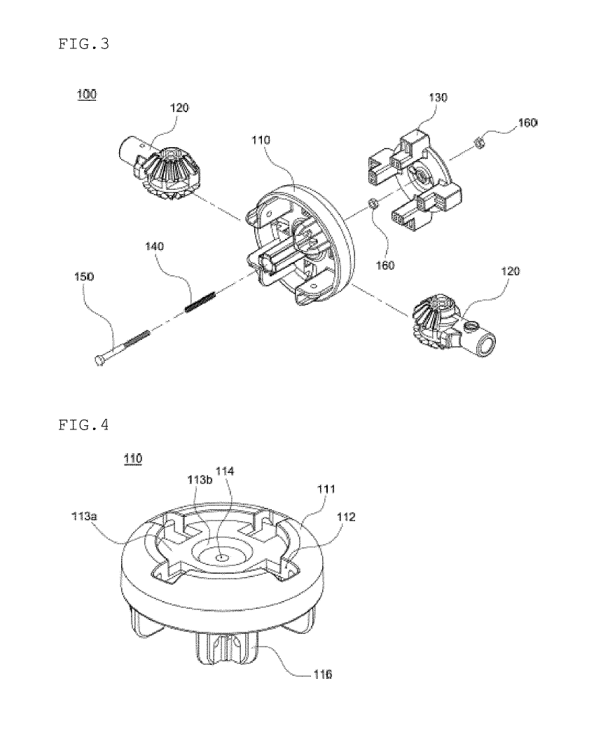

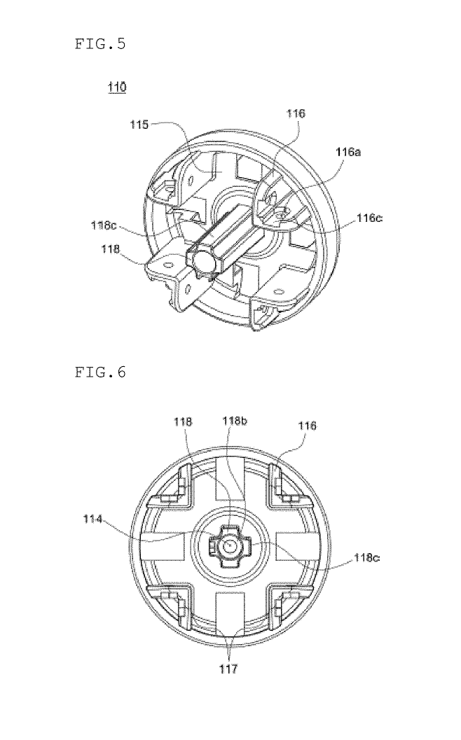

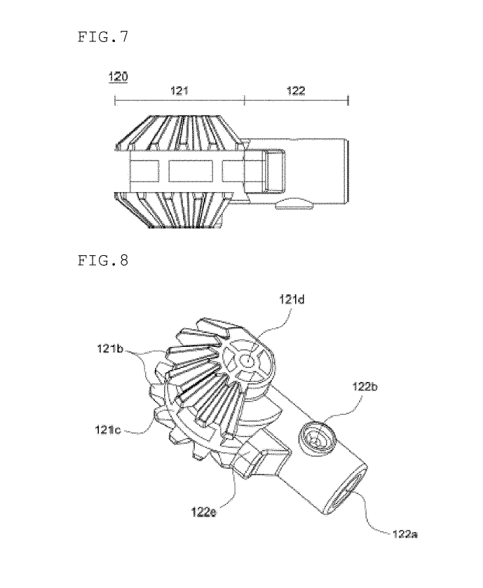

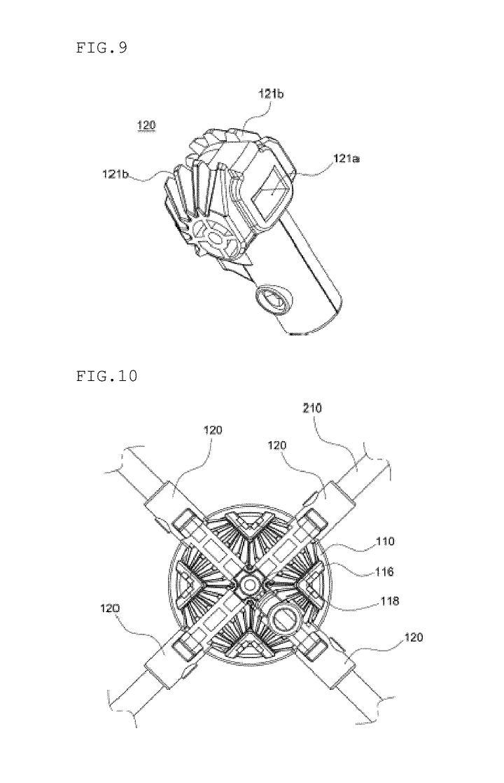

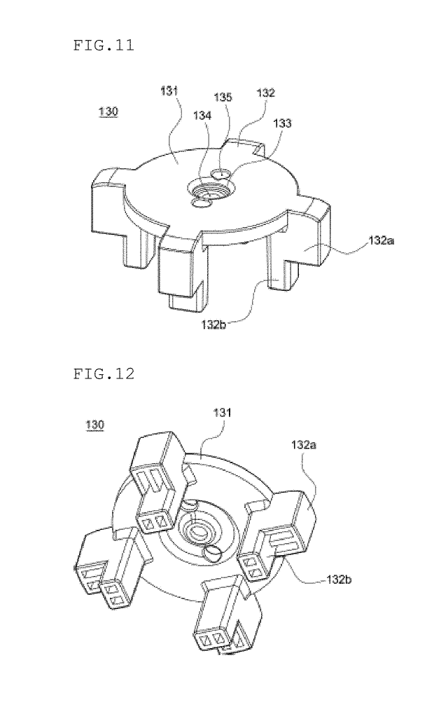

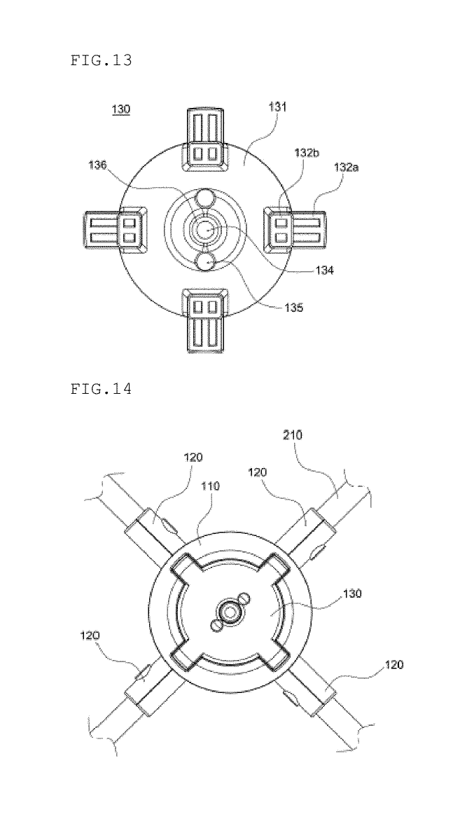

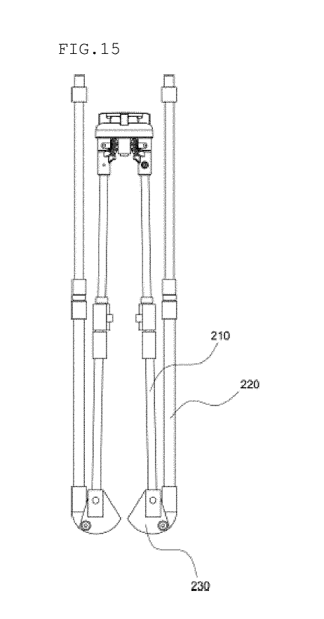

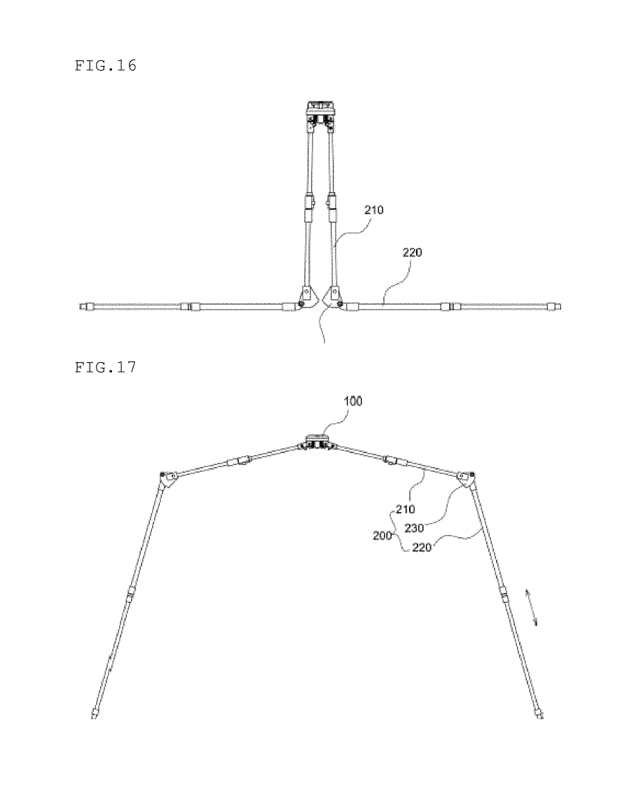

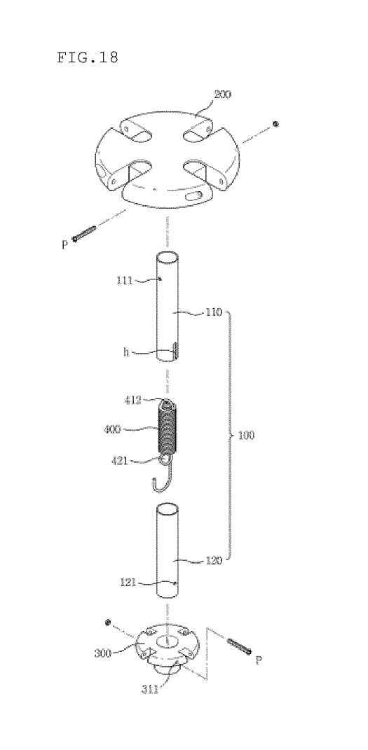

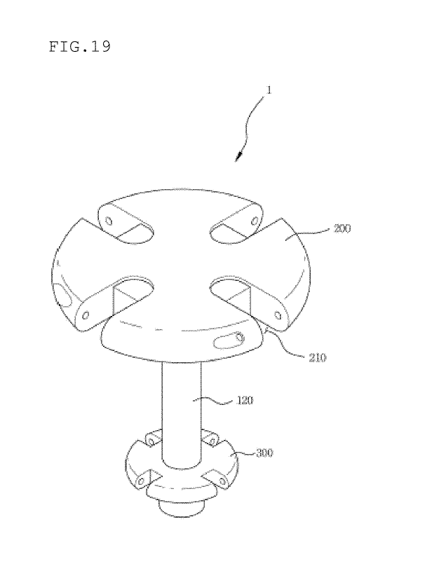

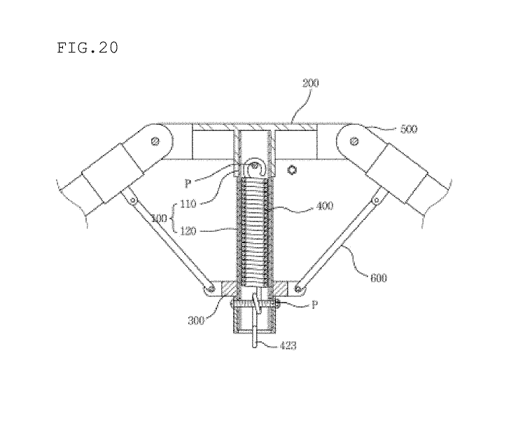

FIG. 1 is a perspective view showing a state where an automatic instant tent frame according to the present invention is unfolded, FIG. 2 is a top view showing the plane of a head in the automatic instant tent frame according to the present invention, FIG. 3 is a partially separate perspective view showing the head, FIG. 4 is a perspective view showing top of a hub in the automatic instant tent frame according to the present invention, FIG. 5 is a perspective view showing underside of the hub, FIG. 6 is a bottom view showing space portions on the underside of the hub, FIG. 7 is a side view showing a pole coupler in the automatic instant tent frame according to the present invention, FIG. 8 is a perspective view showing a guider and a friction prevention projection of the pole coupler, FIG. 9 is a perspective view showing a locking groove and a connection gear of the pole coupler, FIG. 10 is a top view showing a state where pole couplers are coupled to the hub in the automatic instant tent frame according to the present invention, FIG. 11 is a perspective view showing top of a stopper in the automatic instant tent frame according to the present invention, FIG. 12 is a perspective view showing underside of the stopper, FIG. 13 is a bottom view showing the stopper, FIG. 14 is a top view showing the plane state of the automatic instant tent frame according to the present invention, FIG. 15 is a perspective view showing legs when an automatic instant tent is folded, FIG. 16 is a perspective view showing a state where lower poles of the legs are unfolded so as to unfold the automatic instant tent, and FIG. 17 is a perspective view showing a state where the automatic instant tent is completely unfolded.

As shown in FIGS. 1 to 17, an automatic instant tent frame 1 according to the present invention includes a head 100 serving as an upper structure adapted to collectively couple a plurality of legs 200 thereto to keep a framework of an automatic instant tent and the plurality of legs 200 serving as a lower structure adapted to provide the framework of the automatic instant tent so as to support a tent cloth thereagainst and thus to provide an outer shape of the automatic instant tent, each leg 200 having an upper pole 210 and a lower pole 220 coupled integrally to each other by means of a pole connector 230, wherein the head 100 includes: a hub 110 for collectively coupling a plurality of pole couplers 120 thereto; the plurality of pole couplers 120 each having one end portion coupled to one end of the upper pole 210 and the other end pivot-coupled to a corresponding coupling wall 116 of the hub 110; a stopper 130 coupled to top of the hub 110 to selectively keep an unfolded or folded state of the plurality of pole couplers 120 pivot-coupled to the hub 110; a compression spring 140 fitted to a through hole 118a formed on the center of a coupling pillar 118 of the hub 110; coupling nuts 160 disposed on top and underside of the stopper 130; and a coupling bolt 150 fitted to the compression spring 140 in such a manner as to be coupled to top and underside of a circular plate 131 of the stopper 130 coupled to the top of the hub 110 by means of the coupling nuts 160.

Hereinafter, the automatic instant tent frame 1 according to the present invention will be in detail explained.

As shown in FIG. 1, the automatic instant tent frame 1 according to the present invention includes the head 100 and the plurality of legs 200 coupled integrally to each other.

In detail, the automatic instant tent frame 1 according to the present invention includes the head 100 serving as the upper structure adapted to collectively couple the plurality of legs 200 thereto and the plurality of legs 200 serving as the lower structure adapted to support the tent cloth thereagainst so as to provide the outer shape of the tent, and at this time, the head 100 and the plurality of legs 200 are coupled integrally to each other.

First, the head 100 collectively couples the plurality of legs 200.

As shown in FIGS. 2 and 3, the head 100 includes the hub 110 for collectively coupling the plurality of pole couplers 120 thereto, each pole coupler 120 having one end coupled to one end of the upper pole 210, the plurality of pole couplers 120 each having one end portion coupled to one end of the upper pole 210 and the other end pivot-coupled to the coupling wall 116 of the hub 110, the stopper 130 coupled to top of the hub 110 to selectively keep the unfolded or folded state of the plurality of pole couplers 120 pivot-coupled to the hub 110, the compression spring 140 fitted to the through hole 118a formed on the center of the coupling pillar 118 of the hub 110, the coupling nuts 160 disposed on top and underside of the stopper 130, and the coupling bolt 150 fitted to the compression spring 140 in such a manner as to be coupled to top and underside of the circular plate 131 of the stopper 130 coupled to the top of the hub 110 by means of the coupling nuts 160.

The head 100 is configured to allow lower locking portions 132b of locking portions 132 of the stopper 130 to be sufficiently inserted, through insertion holes 112 formed on top of the hub 110, into locking grooves 121a of the pole couplers 120 pivot-coupled to the hub 110.

At this time, the compression spring 140 becomes in a state of a free length.

In detail, the state of the head 100 is the state at the time when the tent is unfolded.

Further, the hub 110 of the head 100 is adapted to collectively couple the plurality of pole couplers 120 thereto, and at this time, each pole coupler 120 has one end coupled to one end of the upper pole 210.

As shown in FIGS. 4 to 6, the hub 110 includes a flat disc-shaped body 111 open on the underside thereof, the insertion holes 112 formed piercedly on four corners of top of the body 111, a circular first fitting portion 113a having a given diameter formed on the center of top of the body 111, a circular second fitting portion 113b having a given diameter formed on the center of the first fitting portion 113a, and a coupling bolt insertion hole 114 formed piercedly on the center of the second fitting portion 113b.

The first fitting portion 113a and the second fitting portion 113b may have various shapes, without being limited to the circular shapes.

In detail, the hub 110 has the flat disc-shaped body 111 open on the underside thereof.

The four insertion holes 112 are formed piercedly on the four corners of top of the body 111.

The insertion holes 112 may have various shapes like square, rectangle, circle, and so on, without being limited thereto.

The circular first fitting portion 113a having the given diameter is formed on the center of top of the body 111.

Further, the circular second fitting portion 113b having the given diameter is formed on the center of the first fitting portion 113a, and the coupling bolt insertion hole 114 is formed piercedly on the center of the second fitting portion 113b.

The first fitting portion 113a is adapted to accommodate the circular plate 131 of the stopper 130 therein.

Also, the second fitting portion 113b is adapted to accommodate a convex portion 136 formed on the underside of the circular plate 131 of the stopper 130 therein.

Further, the second fitting portion 113b serves as a space for accommodating ties (not shown) made on hooks (not shown) inserted into hook holes 135 of the stopper 130 as will be discussed later therein.

At this time, the hooks serve as handles of the stopper 130.

Next, as shown in FIGS. 5 and 6, the body 111 includes a fitting portion 115 formed over the underside thereof and the four “¬”-shaped coupling walls 116 formed between the insertion holes 112 in such a manner as to protrude downward from the underside thereof.

Further, each coupling wall 116 has pivot coupling holes 116a formed piercedly thereon to couple the pivots (not shown) thereto and fitting portions 116c formed around the pivot coupling holes 116a to help the pivots gently coupled to the pivot coupling holes 116a.

In detail, the body 111 includes the fitting portion 115 formed over the underside thereof.

The four “¬”-shaped coupling walls 116 are formed between the insertion holes 112 in such a manner as to protrude downward from the underside of the body 111.

Further, each coupling wall 116 has the pivot coupling holes 116a formed piercedly thereon to couple the pivots thereto.

Further, the fitting portions 116c are formed around the pivot coupling holes 116a to help the pivots gently coupled to the pivot coupling holes 116a.

As shown in FIGS. 6 and 10, the pole couplers 120 are pivot-coupled to space portions 117 formed between the adjacent coupling walls 116.

As shown in FIG. 6, the body 111 has the hollow pipe-like coupling pillar 118 protruding downward from the center of underside thereof around the coupling bolt insertion hole 114.

As shown in FIG. 3, the coupling pillar 118 has a through hole 118a formed at the center thereof in such a manner as to insert the compression spring 140 and the coupling bolt 150 thereinto.

The compression spring 140 is inserted into the through hole 118a, and the coupling bolt 150 is fitted to the compression spring 140. Next, the end of the coupling bolt 150 is fastened to the top and underside of the stopper 130 coupled to the top of the hub 110 by means of the coupling nuts 160.

The through hole 118a becomes large up to a given length on a lower side thereof and becomes small from the given position, thereby forming a stepped projection 118b as shown in FIG. 6.

The stepped projection 116b serves as a support projection for supporting the other side of the compression spring 140 whose one side is supported against the head of the coupling bolt 150 fitted thereto.

Next, as shown in FIG. 5, the coupling pillar 118 has four guider support rails 118c formed elongatedly in up and down directions along the outer peripheral surface thereof in such a manner as to correspond to the guiders 121c of a gear portion 121 of each pole coupler 120 to support the guiders 121c thereagainst.

At this time, when the four pole couplers 120 are at the same time folded and unfolded, as shown in FIGS. 5 and 10, the guiders 121c of the pole couplers 120 are supported against the guider support rails 118c formed elongatedly in the up and down directions along the outer peripheral surface of the coupling pillar 118 of the hub 110, thereby obtaining supporting forces.

On the other hand, one end of each pole coupler 120 is coupled to one end of the upper pole 210, and the other end thereof is pivot-coupled to the hub 110.

The pole couplers 120 serve to couple the legs 200 to the hub 110 in an efficient way.

As shown in FIGS. 7 to 10, each pole coupler 120 includes the gear portion 121 located on one side thereof and a pipe-shaped upper pole coupling portion 122 extended from the other side of the gear portion 121. As shown in FIG. 9, the gear portion 121 includes the locking groove 121a formed on a top portion thereof, left and right connection gears 121b formed on left and right sides of the locking groove 121a, the guider 121c roundedly formed between the left and right connection gears 121b over underside thereof behind the locking groove 121a, and pivot fastening holes 121d formed piercedly on the centers of side portions of the left and right connection gears 121b. The pipe-shaped upper pole coupling portion 122 is open on one end thereof to form an upper pole coupling hole 122a coupled to a top end periphery of the upper pole 210 and is bonded to the gear portion 121 on the other end thereof. The upper pole coupling portion 122 includes an upper pole fixing hole 122b formed piercedly on one side thereof to insert an upper pole fixing bolt (not shown) and an upper pole fixing nut (not shown) for fixing the top end periphery of the upper pole 210 thereto thereinto, and a friction prevention projection 122e protruding from the underside of an upper end periphery thereof.

In detail, as shown in FIG. 7, each pole coupler 120 includes the gear portion 121 and the upper pole coupling portion 122.

As shown in FIG. 9, the gear portion 121 has the locking groove 121a formed on the top portion thereof.

The locking groove 121a may have various shapes like square, rectangle, circle, and so on, without being limited thereto.

The left and right connection gears 121b are symmetrically formed spaced apart from each other on left and right sides of the locking groove 121a, and each connection gear 121b has ¼ cone-shaped teeth.

As shown in FIG. 10, each connection gear 121b is a straight bevel gear whose teeth have shapes of ¼ cones, so that the adjacent two shafts, pole couplers 120 are engaged with each other at a right angle to each other to transfer their motion to each other.

In detail, when the four pole couplers 120 are pivot-coupled to the coupling walls 116 of the hub 110, as shown in FIG. 10, the connection gears 121b of the four pole couplers 120 are engaged with the adjacent connection gears 121b thereto, so that the pole couplers 120 can be at the same time folded and unfolded.

At this time, as shown in FIGS. 8 and 9, the guider 121c is roundedly formed between the left and right connection gears 121b over underside thereof behind the locking groove 121a.

The guider 121c is formed with ¼ circumference of a circle.

When the pole couplers 120 can be at the same time folded and unfolded, as shown in FIGS. 5 and 10, the guiders 121c are supported against the guider support rails 118c formed in the up and down directions along the outer peripheral surface of the coupling pillar 118 of the hub 110, thereby obtaining supporting forces.

Further, the pivot fastening holes 121d are formed piercedly in left and right directions on the centers of side portions of the left and right connection gears 121b.

The pivots (not shown) are fastened to the pivot fastening holes 121d.

On the other hand, as shown in FIG. 8, the friction prevention projection 122e protrudes from the underside of the upper pole coupling portion 122 on the center of the pole coupler 120.

When the pole couplers 120 are folded, the friction prevention projections 122e of the four pole couplers 120 supportingly come into contact with each other to prevent the pole couplers 120 from being worn out due to their friction.

As shown in FIG. 6, the pole couplers 120 are located in the space portions 117 formed between the adjacent coupling walls 116 on the underside of the hub 110, and as shown in FIG. 10, they are pivot-coupled to the pivot coupling holes 116a of the adjacent coupling walls 116 to each other.

On the other hand, the stopper 130 is coupled to the top of the hub 110 and serves to selectively keep the unfolded and folded states of the pole couplers 120 pivot-coupled to the hub 110.

As shown in FIGS. 11 to 13, the stopper 130 includes the circular plate 131, as a body thereof, having a diameter corresponding to the diameter of the first fitting portion 113a formed on top of the hub 110 and the four locking portions 132 protruding outward from four corners of the circular plate 131 in such a manner as to be unitarily formed with the circular plate 131. The circular plate 131 includes a circular fitting portion 133 having a given diameter formed on the center of top thereof in such a manner as to seat the coupling nuts 160 therein and the circular convex portion 136 formed on the center of underside thereof in such a manner as to be accommodated in the second fitting portion 113b of the hub 110, a coupling hole 134 formed piercedly on the center of the fitting portion 133, and the two hook holes 135 formed radially around the coupling hole 134 to seat the hooks as the handles of the stopper 130 therein.

In detail, the circular fitting portion 133 having the given diameter is formed on the center of top of the circular plate 131, and the circular convex portion 136 is formed on the center of underside of the circular plate 131 in such a manner as to be accommodated in the second fitting portion 113b of the hub 110.

The circular convex portion 136 is accommodated in the second fitting portion 113b of the hub 110, so that a coupling force between the stopper 130 and the hub 110 can be increased to provide stability to them.

The second fitting portion 113b of the hub 110 serves as the space for accommodating the ties made on the hooks inserted into the hook holes 135 of the stopper 130 therein.

At this time, the hooks serve as handles of the stopper 130.

The stopper 130 includes the circular plate 131 inserted into the first fitting portion 113a formed on top of the hub 110 and the four locking portions 132 protruding outward from the four corners of the circular plate 131 in such a manner as to be unitarily formed with the circular plate 131. As shown in FIG. 14, in detail, the circular plate 131 and the four locking portions 132 of the stopper 130 are inserted into the first fitting portion 113a and the four insertion holes 112 formed on top of the hub 110, so that the stopper 130 is coupled integrally to the hub 110.

As shown in FIG. 11, each locking portion 132 includes an upper locking portion 132a and the lower locking portion 132b molded unitarily with each other to the shape of “¬”.

As shown in FIGS. 11 to 13, the stopper 130 is configured to allow the four corners of the outer periphery of the circular plate 131 to be bonded unitarily to the upper locking portions 132a of the locking portions 132.

Each upper locking portion 132a has a given length so that if the stopper 130 pulls from the hub 110 to fold the tent, the lower end of the upper locking portion 132a is not deviated from the hub 110 to the outside.

At this time, the length of each lower locking portion 132b is equal to a depth of the locking groove 121a, but desirably, it is shorter than the depth of the locking groove 121a.

Next, the plurality of legs 200 serves as the framework for supporting the tent cloth 2 thereagainst to provide the outer shape of the tent.

As shown in FIGS. 1 and 15 to 17, each leg 200 generally has the upper pole 210 and the lower pole 220 coupled integrally to each other by means of the pole connector 230.

Each or any one of the upper pole 210 and the lower pole 220 is retractably foldable.

The foldable pole is adopted in the embodiment of the present invention.

Now, an explanation on an operation of the automatic instant tent frame 1 according to the present invention will be in detail given.

FIG. 15 shows the legs 200 when the automatic instant tent is folded. The stopper 130 of the head 100 is raised upward.

FIG. 16 shows a state where the lower poles 220 of the legs 200 are unfolded to unfold the automatic instant tent. The stopper 130 of the head 100 is still raised upward.

FIG. 17 shows a state where the automatic instant tent is completely unfolded. It can be appreciated that the stopper 130 of the head 100 is coupled to the hub 110 of the head 100.

First, the pole couplers 120 are located in the four space portions 117 among the four coupling walls 116 protruding downward from the underside of the hub 110 of the hub 100, and the pivot coupling holes 116a of the coupling walls 116 of the hub 110 correspond to the pivot fastening holes 121d of the pole couplers 120, so that the pivots are fastened to the pivot coupling holes 116a and the pivot fastening holes 121d.

Next, the four locking portions 132 of the stopper 130 are inserted correspondingly into the four insertion holes 112 formed on top of the hub 110 until the end portions of the lower locking portions 132b of the locking portions 132 come into contact with the bottoms of the locking grooves 121a of the pole couplers 120, and after that, the compression spring 140 and the coupling bolt 150 are sequentially inserted into the lower portion of the through hole 118a formed on the center of the coupling pillar 118 protruding from the underside of the hub 110. Next, the coupling nuts 160 are fastened to the end portion of the coupling bolt 150 on the top and underside of the circular plate 131 of the stopper 130, so that the structure of the head 100 is completely made.

In detail, the compression spring 140 is inserted into the through hole 118a, the coupling bolt 150 is fitted to the compression spring 140, and the coupling nuts 160 are fastened to the end portion of the coupling bolt 150 on the top and underside of the circular plate 131 of the stopper 130, so that the hub 110 and the stopper 130 are fixed to each other to completely make the structure of the head 100.

The stopper 130 is configured to allow the top and underside of the circular plate 131 to be fixedly fastened to the coupling bolt 150 by means of the coupling nuts 160 in the state where the lower locking portions 132b of the locking portions 132 of the stopper 130 are sufficiently inserted into the locking grooves 121a of the pole couplers 120 pivot-coupled to the hub 110 through the insertion holes 112 on top of the hub 110, so that the stopper 130 constitutes a portion of the head 100.

At this time, the state of the head 100 is the state at the time when the tent is unfolded.

At this time, further, the compression spring 140 becomes in a state of a free length.

If the pole couplers 120 are folded, the lower locking portions 132b of the locking portions 132 of the stopper 130 are deviated from the locking grooves 121a of the pole couplers 120 and thus supported against the guiders 121c of the pole couplers 120, so that the stopper 130 is raised upward from the hub 110. At this time, the stopper 130 pulls the coupling bolt 150 coupled thereto to allow the compression spring 140 to become compressed.

If the pole couplers 120 are unfolded, the lower locking portions 132b of the locking portions 132 of the stopper 130 are guidedly moved along the guiders 121c of the pole couplers 120 in such a manner as to reach the locking grooves 121a of the pole couplers 120, and accordingly, they are inserted into the locking grooves 121a by means of the restoring force of the compression spring 14 to allow the pole couplers 120 to be locked thereonto, so that the framework of the tent can be provided.

Next, the upper poles 210 and the lower poles 220 are coupled integrally to each other by means of the pole connectors 230, thereby providing the four legs 200.

After that, the top end peripheries of the upper poles 210 of the four legs 200 are inserted into the upper pole coupling holes 122a of the four pole couplers 120 coupled to the head 100, and next, they are fixedly coupled to the four pole couplers 120 by means of the upper pole fixing bolt and the upper pole fixing nut provided to the upper pole fixing holes 122b of the pole couplers 120, thereby providing the automatic instant tent frame 1 according to the present invention.

Next, the automatic instant tent frame 1 and the tent cloth 2 are coupled to each other, thereby providing an automatic instant tent.

So as to install the automatic instant tent, it is moved to an installation place and is thus located at a desired position.

The lower poles 220 of the four legs 200 of the automatic instant tent are unfolded in every direction, and next, if the upper poles 210 are taken, moved up, and then moved down, the pole couplers 120 are unfolded to allow the lower locking portions 132b of the locking portions 132 of the stopper 130 to be guidedly moved along the guiders 121c of the pole couplers 120 in such a manner as to reach the locking grooves 121a of the pole couplers 120. At this time, the lower locking portions 132b of the locking portions 132 of the stopper 130 are inserted into the locking grooves 121a by means of the restoring force of the compression spring 14 to allow the pole couplers 120 to be locked thereonto in the state where the pole couplers 120 are unfolded, so that the framework of the automatic instant tent can be provided.

Next, if the retractable lower poles 220 of the legs 200 are drawn to the outside to keep a general shape of tent, the upper poles 210 are elastic so that they provide the framework of the tent.

After that, if the tent is pegged down on both sides thereof, the installation of the tent can be completed rapidly and easily.

So as to fold the tent, pegs are removed from both sides of the tent, and the retractable lower poles 220 are insertedly retracted. Next, if the hooks of the stopper 130 pull upward, the lower locking portions 132b of the locking portions 132 of the stopper 130 are deviated from the locking grooves 121a of the pole couplers 120 and thus released from the coupled states to the pole couplers 120, so that the upper poles 210 are instantly folded inward by means of the elasticity applied thereto and the lower locking portions 132b of the stopper 130 are supported against the guiders 121c of the pole couplers 120, thereby allowing the stopper 130 to be raised upward from the hub 110. At this time, the stopper 130 pulls the coupling bolt 150 coupled to the circular plate 131, so that the compression spring 140 whose one end is supported against the stepped projection 118b of the through hole 118a becomes compressed.

Next, the folded automatic instant tent is organized and kept appropriately.

As mentioned above, the automatic instant tent frame according to the present invention is configured wherein if the stopper 130 pulls from the hub 110 to allow the coupled relation between the hub 110 and the stopper 130 to be released, the upper poles 210 are automatically folded by means of the their elasticity to allow the legs 200 to be at the same time folded, so that the installation and removal of the automatic instant tent can be achieved in rapid, simple, and easy manners, the danger in the installation or removal of the automatic instant tent like damage to the user's hand caught to the frame can be removed, and abrasion or failure caused by friction between frame components at the time when the automatic instant tent is folded or in the state where the automatic instant tent is folded can be avoided.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An automatic instant tent frame comprising:
a head (100) serving as an upper structure adapted to collectively couple a plurality of legs (200) thereto; and
the plurality of legs (200) serving as a lower structure adapted to provide a framework of an automatic instant tent and to support a tent cloth thereagainst to provide an outer shape of the automatic instant tent, each leg (200) having an upper pole (210) and a lower pole (220) coupled integrally to each other by means of a pole connector (230),
wherein the head (100) comprises:
a hub (110) for collectively coupling a plurality of pole couplers (120) thereto;
the plurality of pole couplers (120) each having one end portion coupled to one end of the upper pole (210) and the other end pivot-coupled to a corresponding coupling wall (116) of the hub (110);
a stopper (130) coupled to top of the hub (110) to selectively keep an unfolded or folded state of the plurality of pole couplers (120) pivot-coupled to the hub (110);
a compression spring (140) fitted to a through hole (118a) formed on the center of a coupling pillar (118) of the hub (110);
coupling nuts (160) disposed on top and underside of the stopper (130); and
a coupling bolt (150) fitted to the compression spring (140) in such a manner as to be coupled to top and underside of a circular plate (131) of the stopper (130) coupled to the top of the hub (110) by means of the coupling nuts (160).

2. The automatic instant tent frame according to claim 1, wherein the hub (110) comprises:
a flat disc-shaped body (111) open on the underside thereof;
four insertion holes (112) formed on four corners of top of the body (111);
a circular first fitting portion (113a) having a given diameter formed on the center of top of the body (111);
a circular second fitting portion (113b) having a given diameter formed on the center of the first fitting portion (113a); and
a coupling bolt insertion hole (114) formed piercedly on the center of the second fitting portion (113b).

3. The automatic instant tent frame according to claim 2, wherein the body (111) comprises:
a fitting portion (115) formed over the underside thereof;
the four coupling walls (116) having a shape of “¬” in such a manner as to protrude downward from the underside thereof between the insertion holes (112); and
the coupling pillar (118) having a shape of a hollow pipe in such a manner as to protrude downward from the center of the underside thereof around the coupling bolt insertion hole (114).

4. The automatic instant tent frame according to claim 3, wherein the coupling pillar (118) has four guider support rails (118c) formed elongatedly in up and down directions along the outer peripheral surface thereof in such a manner as to correspond to guiders (121c) of a gear portion (121) of each pole coupler (120) to support the guiders (121c) thereagainst.

5. The automatic instant tent frame according to claim 1, wherein each pole coupler (120) comprises:
the gear portion (121) located on one side thereof; and
a pipe-shaped upper pole coupling portion (122) extended from the other side of the gear portion (121),
the gear portion (121) comprising:
a locking groove (121a) formed on a top portion thereof;
left and right connection gears (121b) formed on left and right sides of the locking groove (121a);
the guider (121c) roundedly formed between the left and right connection gears (121b) over underside thereof behind the locking groove (121a); and
pivot fastening holes (121d) formed piercedly on the centers of side portions of the left and right connection gears (121b),
and the pipe-shaped upper pole coupling portion (122) being open on one end thereof to form an upper pole coupling hole (122a) coupled to a top end periphery of the upper pole (210) and being bonded to the gear portion (121) on the other end thereof,
the upper pole coupling portion (122) comprising:
an upper pole fixing hole (122b) formed piercedly on one side thereof to insert an upper pole fixing bolt and an upper pole fixing nut for fixing the top end periphery of the upper pole (210) thereto thereinto; and
a friction prevention projection (122e) protruding from the underside of an upper end periphery thereof.

6. The automatic instant tent frame according to claim 5, wherein each connection gear (121b) is a straight bevel gear whose teeth have shapes of ¼ cones, so that the adjacent two shafts, pole couplers (120) are engaged with each other at a right angle to each other to transfer a motion to each other.

7. The automatic instant tent frame according to claim 1, wherein the stopper (130) comprises:
the circular plate (131) as a body thereof having a diameter corresponding to the diameter of the first fitting portion (113a) formed on the top of the hub (110);
four locking portions (132) protruding outward from four corners of the circular plate (131) in such a manner as to be formed unitarily with the circular plate (131);
a circular fitting portion (133) having a given diameter formed on the center of top of the circular plate (131) in such a manner as to seat the coupling nuts (160) therein;
a circular convex portion (136) formed on the center of underside of the circular plate (131) in such a manner as to be accommodated in the second fitting portion (113b) of the hub (110);
a coupling hole (134) formed piercedly on the center of the fitting portion (133); and
two hook holes (135) formed radially around the coupling hole (134) to seat hooks as handles of the stopper (130) therein.

8. The automatic instant tent frame according to claim 1, wherein the stopper (130) and the hub (110) are coupled to each other by correspondingly inserting the circular plate (131) and the four locking portions (132) protruding outward from the circular plate (131) as a unitary body with the circular plate (131) into the first fitting portion (113a) and the four insertion holes (112) formed on the top of the hub (110).

9. The automatic instant tent frame according to claim 8, wherein each locking portion (132) comprises an upper locking portion (132a) and a lower locking portion (132b) formed to the shape of “¬”, the upper locking portion (132a) having a given length, so that if the stopper (130) pulls from the hub (110) so as to fold the automatic instant tent, the lower end of the upper locking portion (132a) has no deviation from the hub (110) to the outside, and a length of the lower locking portion (132b) corresponding to a depth of the locking groove (121a) but being shorter than the depth of the locking groove (121a).
